(19) United States
(12) Patent Application Publication
(10) Pub. No.: US 2018/0185863 A1
(43) Pub. Date: Jul. 5, 2018

(54) GARDENING WATER SPRAY GUN

(71) Applicant: Chin-Yuan Chen, Changhua (TW)

(72) Inventor: Chin-Yuan Chen, Changhua (TW)

(73) Assignee: SHIN TAI SPURT WATER OF THE GARDEN TOOLS CO., LTD., CHANGHUA (TW)

(21) Appl. No.: 15/399,500

(22) Filed: Jan. 5, 2017

(51) Int. Cl. B05B 9/01; B05B 1/16; B05B 12/00

(52) U.S. Cl. CPC B05B 9/01; B05B 12/002; B05B 1/1609; B05B 1/169

(57) ABSTRACT

A gardening water spray gun may include a main body, a water guiding tube, a guiding sleeve, an axle shaft, a nozzle cap, a control ring, a spray head and a block ring. The water spray gun of the present invention not only has the functions of garden watering and item washing but also is configured to provide powerful and wide-range water stream as a water bloom, which is configured to easily remove dust and dirt attached on the wall or floor and improve the practicability of the water spray gun.

### FIELD OF THE INVENTION

The present invention relates to a gardening water spray gun, and more particularly to a gardening water spray gun configured to generate powerful and wide-range water stream.

### BACKGROUND OF THE INVENTION

Referring to FIGS. 11 and 12, a conventional gardening water spray gun has a main body (90) and a spray head (91). Wherein the main body (90) has a handle (901) and a barrel portion (902). A front end of the barrel portion (902) is connected to a water outlet column (92), and a valve rod (93) having a sealing pad (931) is secured therein. A rear end of the valve rod (93) is configured to stick out of the main body (90) and connect to a pressing unit (94) which is pivotally connected on the handle (901). Thus, through operating the pressing unit (94), the valve rod (93) is configured to be driven and to move inside the barrel portion (902) to control the on/off operation of the water spray gun. Moreover, at least a spring (95) is formed between the sealing pad (931) and a lateral side of the barrel portion (902), and a flow channel (921) having an opening at a rear end thereof is formed inside the water outlet column (92). A front portion of the flow channel (921) comprises at least two outlet holes (922) laterally penetrating the water outlet column (92), and a front end of the water outlet column (92) is pivotally connected to a spray head (91). Furthermore, a stepped rod (923) is formed at a front end of the water outlet column (92), and a spray head (91) has a tapered portion (911). The spray head (91) is configured to be turned in one direction to adjust the distance between the stepped rod (923) and the tapered portion (911), thus performing the solid stream pattern (as shown in FIG. 11) or the full cone pattern (as shown in FIG. 12).

However, the conventional gardening water spray gun has its disadvantages because: it only can spray water in said two patterns which have their shortcomings. Wherein the solid stream pattern cannot be applied to a large scale of spraying while the full cone pattern is short of providing the powerful water stream, thereby reducing the practicability of the water spray gun. Therefore, there remains a need for a new and improved design for a water spray gun to overcome the problems presented above.

### SUMMARY OF THE INVENTION

The present invention provides a gardening water spray gun which comprises a main body, a water guiding tube, a guiding sleeve, an axle shaft, a nozzle cap, a control ring, a spray head and a block ring. The main body has a handle and a barrel portion, which are connected and communicated with each other. A connecting opening is formed at a front end of the barrel portion, and a water-resisting cover and an abutting edge are respectively formed inside the connecting opening. A first threaded section formed at an outer periphery of the front end of the barrel portion is configured to allow the nozzle cap to engage thereon. The water guiding tube has a close end and an open end, which are respectively formed at a front end and a rear end of the water guiding tube. A water outlet hole axially penetrates through the close end, and the close end further has an elongated water guiding groove which passes through the water outlet hole. A first sealing ring is disposed on an outer periphery of the open end, and a second threaded section is formed at an outer periphery of the close end. A plurality of engaging blocks formed at an outer periphery of the water guiding tube are located close to the open end such that each of water flow channels is formed between two adjacent engaging blocks. The guiding sleeve has a flange, and an outer tube protrudes from a front end thereof. Also, an inner tube is connected to an inner periphery of the guiding sleeve, and wherein the outer tube is longer than the inner tube. The axle shaft comprises a central hole axially penetrating through a central portion thereof, and an inner diameter of the central hole is slightly larger than an outer diameter of the water guiding tube. A plurality of engaging grooves are formed at a rear portion of the central hole. The central hole is configured to be penetrated by the water guiding tube, and the engaging grooves are configured to be engaged with the engaging blocks, thereby allowing the water guiding tube to connect to and move with the axle shaft synchronously. A connecting hole is formed at an outer periphery of the axle shaft, and a second sealing ring is disposed on a rear portion of the outer periphery of the axle shaft. The nozzle cap comprises a first peripheral cover, and a rear end thereof is connected to a second peripheral cover having a diameter larger than the first peripheral cover. Wherein the first peripheral cover and the second peripheral cover are axially separated to form a peripheral groove therebetween which is configured to receive an outer edge of the connecting opening. A third threaded section is formed at an inner surface of the second peripheral cover, and an elongated hole with a suitable rotation angle penetrates through a surface of the first peripheral cover. Moreover, an extension tube protruding from a front end of the nozzle cap is communicated with an inner space of the nozzle cap, and a fourth threaded section is formed on an outer periphery of the extension tube. When the guiding sleeve is put into the connecting opening of the main body, the flange is configured to bear against the abutting edge to limit a position of the guiding sleeve. Furthermore, the water guiding tube and the axle shaft, which are connected to each other, are configured to be received in the guiding sleeve, and the third threaded section is configured to engage with the first threaded section to allow the flange of the guiding sleeve to be secured between the abutting edge of the main body and a rear end of the first peripheral cover. Since the outer tube is separated with the inner tube, when the water guiding tube and the axle shaft are connected and received in the guiding sleeve, the axle shaft is configured to be received in the outer tube while a rear portion of the water guiding tube is configured to be received in the inner tube. The control ring having a through hole is configured to be disposed on an outer periphery of the nozzle cap, and a connecting unit is configured to sequentially penetrate through the through hole and the elongated hole of the nozzle cap to connect to the connecting hole of the axle shaft such that the control ring, the water guiding tube and the axle shaft are connected and moved synchronously. The spray head comprises a shell and an inner channel, which are connected to each other, and a fifth threaded section is formed at an inner surface of the inner channel. Through engaging the fifth threaded section with the fourth threaded section, the spray head is configured to be secured on the extension tube of the nozzle cap. Also, a stepped portion configured to connect to a tilted surface is connected to a front end of the inner channel, and a sectional diameter of the stepped portion is gradually expanded from a rear end to a front end thereof. The block ring has a sixth threaded section formed at an inner periphery thereof, and the sixth threaded section is configured to engage with the second threaded section of the water guiding tube to allow the block ring to be installed on the water guiding tube. As a result, the water guiding tube is configured to stick out of the spray head, and by turning the spray head, the water spray gun is configured to spay different patterns of water streams from a space between the spray head and the water guiding tube.

Comparing with conventional gardening water spray guns, the present invention is advantageous because: the water spray gun of the present invention not only has the functions of garden watering and item washing but also is configured to provide powerful and wide-range water stream as a water bloom, which is configured to easily remove dust and dirt attached on the wall or floor and improve the practicability of the water spray gun.

### BRIEF DESCRIPTION OF THE DRAWINGS

FIG. 1 is a three-dimensional assembly view of a gardening water spray gun of the present invention.

FIG. 2 is a three-dimensional exploded view of the gardening water spray gun of the present invention.

FIG. 3 is a three-dimensional assembly view from another angle of the gardening water spray gun of the present invention.

FIG. 4 is a schematic view illustrating a control ring of the gardening water spray gun of the present invention is pushed forward.

FIG. 5 is a sectional view illustrating the control ring is pushed forward to allow the gardening water spray gun of the present invention to horizontally spray powerful and wide-range water stream.

FIG. 6 is a three-dimensional view illustrating the control ring is pushed forward to allow the gardening water spray gun of the present invention to horizontally spray powerful and wide-range water stream.

FIG. 7 is a sectional view illustrating the control ring is pushed forward to allow the gardening water spray gun of the present invention to vertically spray powerful and wide-range water stream.

FIG. 8 is a three-dimensional view illustrating the control ring is pushed forward to allow the gardening water spray gun of the present invention to vertically spray powerful and wide-range water stream.

FIG. 9 is a schematic view illustrating a spraying pattern of the gardening water spray gun in the present invention when the control ring is pulled rearward.

FIG. 10 is a schematic view illustrating the control ring is pulled rearward to change the spraying pattern of the gardening water spray gun in the present invention.

FIG. 11 is a prior art.

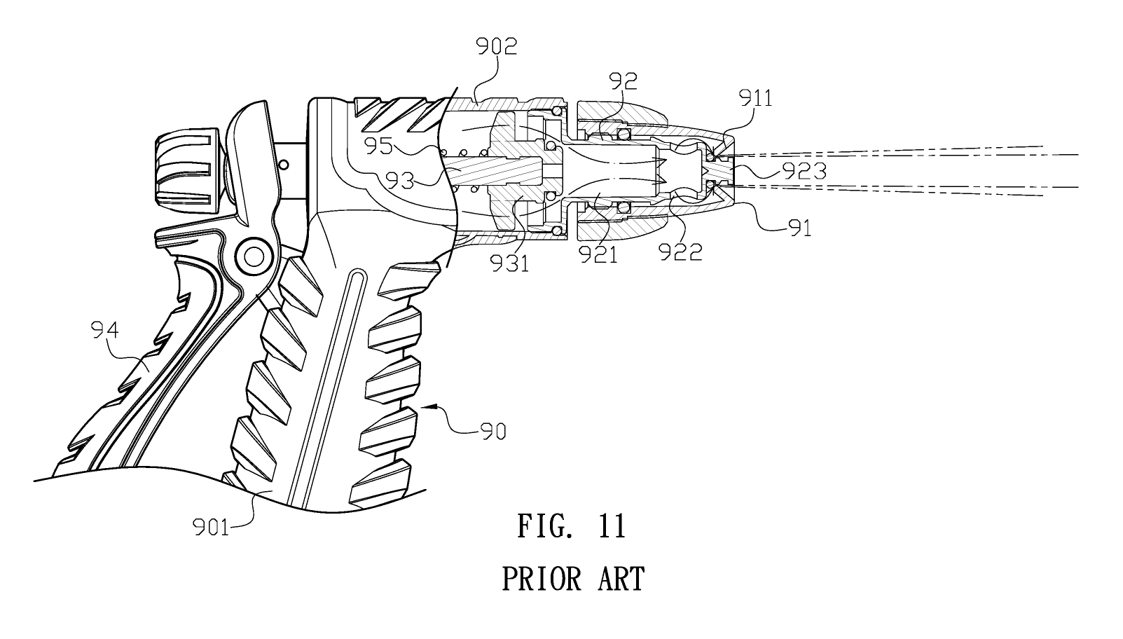

FIG. 12 is a prior art.

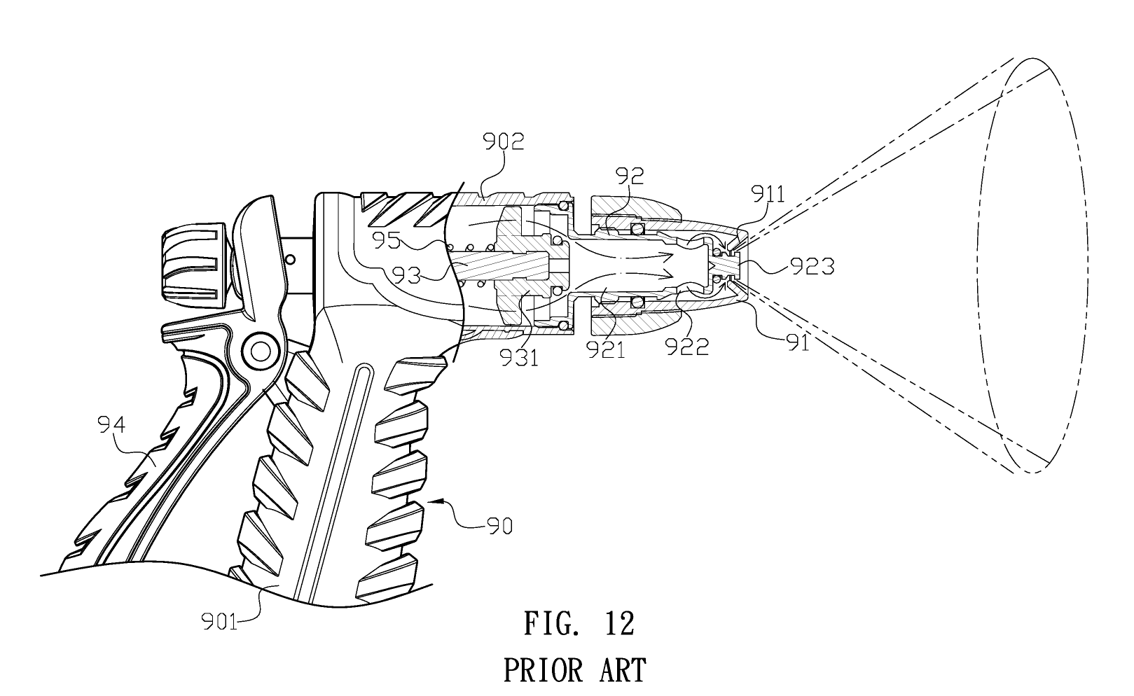

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

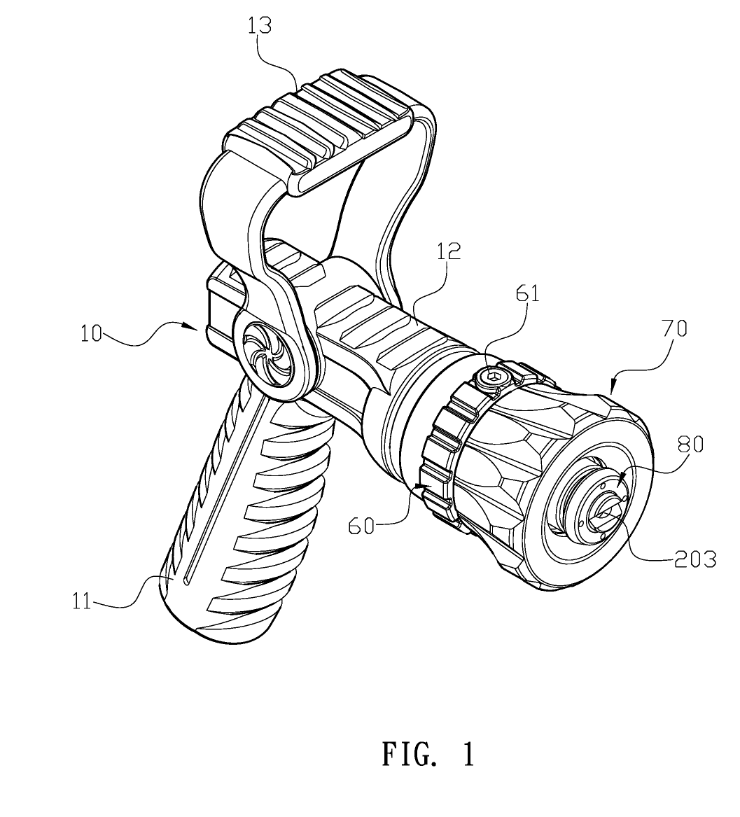

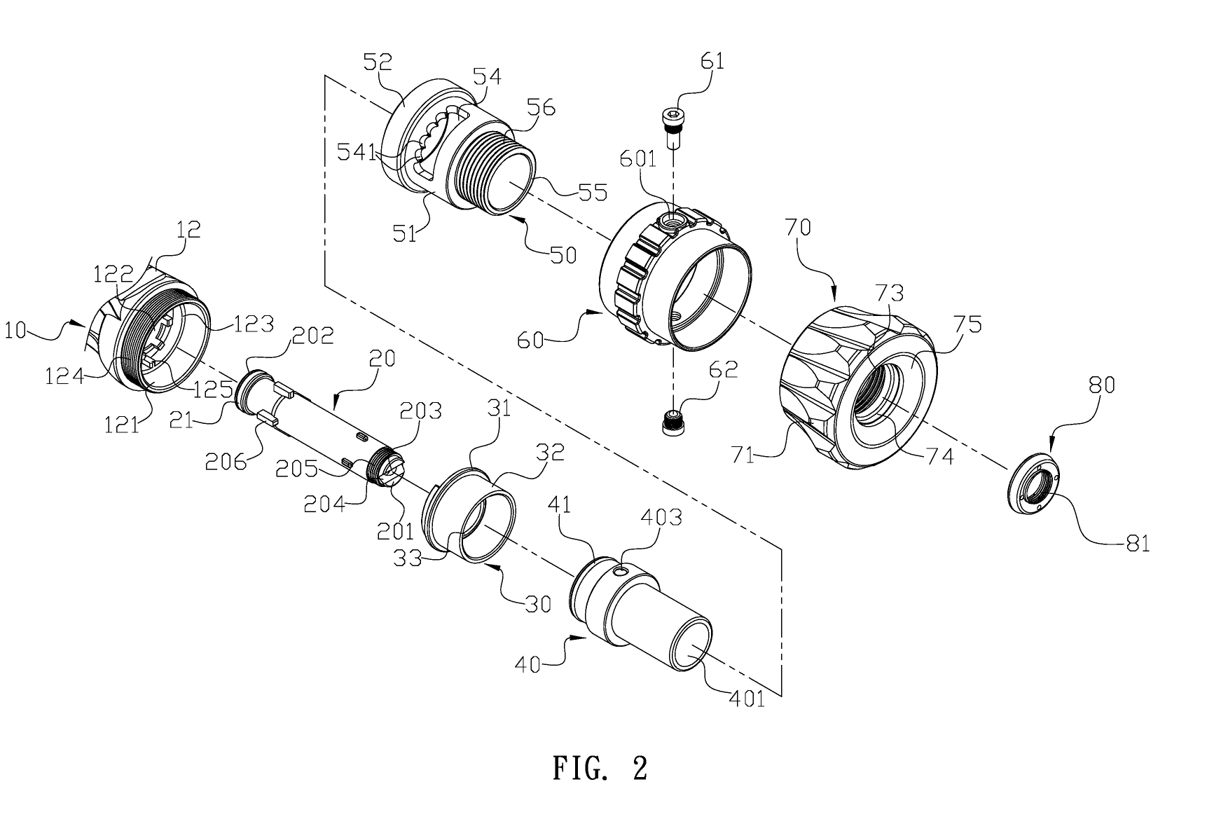

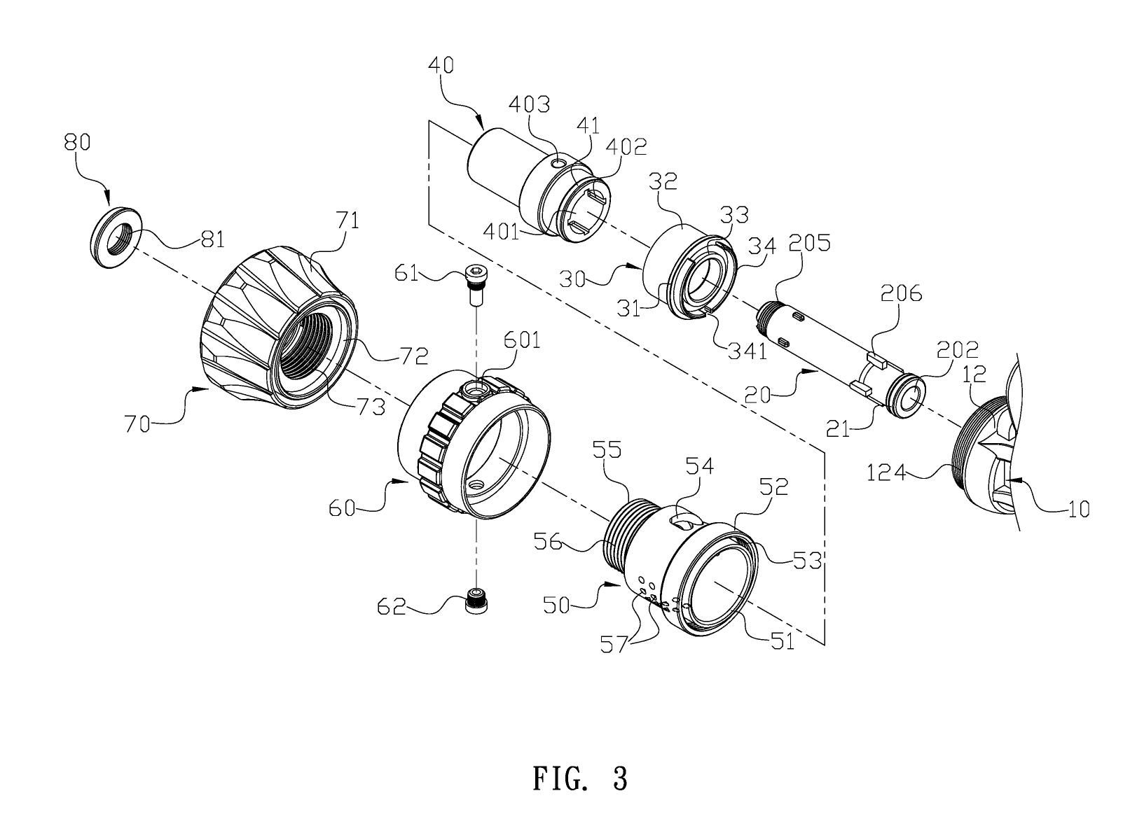

Referring to FIGS. 1 to 4, the present invention provides a gardening water spray gun which comprises a main body (10), a water guiding tube (20), a guiding sleeve (30), an axle shaft (40), a nozzle cap (50), a control ring (60), a spray head (70) and a block ring (80). The main body (10) has a handle (11) and a barrel portion (80), which are connected and communicated with each other. A connecting opening (121) is formed at a front end of the barrel portion (12), and a water-resisting cover (122) and an abutting edge (123) are respectively formed inside the connecting opening (121). A first threaded section (124) formed at an outer periphery of the front end of the barrel portion (12) is configured to allow the nozzle cap (50) to engage thereon. The water guiding tube (20) has a close end (201) and an open end (202), which are respectively formed at a front end and a rear end of the water guiding tube (20). A water outlet hole (203) axially penetrates through the close end (201), and the close end (201) further has an elongated water guiding groove (204) which passes through the water outlet hole (203). A first sealing ring (21) is disposed on an outer periphery of the open end (202), and a second threaded section (205) is formed at an outer periphery of the close end (201). A plurality of engaging blocks (206) formed at an outer periphery of the water guiding tube (20) are located close to the open end (202) such that each of water flow channels is formed between two adjacent engaging blocks (206). The guiding sleeve (30) has a flange (31), and an outer tube (32) protrudes from a front end thereof. Also, an inner tube (33) is connected to an inner periphery of the guiding sleeve (30), and wherein the outer tube (32) is longer than the inner tube (33). The axle shaft (40) comprises a central hole (401) axially penetrating through a central portion thereof, and an inner diameter of the central hole (401) is slightly larger than an outer diameter of the water guiding tube (20). A plurality of engaging grooves (402) are formed at a rear portion of the central hole (401). The central hole (401) is configured to be penetrated by the water guiding tube (20), and the engaging grooves (402) are configured to be engaged with the engaging blocks (206), thereby allowing the water guiding tube (20) to connect to and move with the axle shaft (40) synchronously. A connecting hole (403) is formed at an outer periphery of the axle shaft (40), and a second sealing ring (41) is disposed on a rear portion of the outer periphery of the axle shaft (40). The nozzle cap (50) comprises a first peripheral cover (51), and a rear end thereof is connected to a second peripheral cover (52) having a diameter larger than the first peripheral cover (51). Wherein the first peripheral cover (51) and the second peripheral cover (52) are axially separated to form a peripheral groove therebetween which is configured to receive an outer edge of the connecting opening (121). A third threaded section (53) is formed at an inner surface of the second peripheral cover (52), and an elongated hole (54) with a suitable rotation angle penetrates through a surface of the first peripheral cover (51). Moreover, an extension tube (55) protruding from a front end of the nozzle cap (50) is communicated with an inner space of the nozzle cap (50), and a fourth threaded section (56) is formed on an outer periphery of the extension tube (55). When the guiding sleeve (30) is put into the connecting opening (121) of the main body (10), the flange (31) is configured to bear against the abutting edge (123) to limit a position of the guiding sleeve (30). Furthermore, the water guiding tube (20) and the axle shaft (40), which are connected to each other, are configured to be received in the guiding sleeve (30), and the third threaded section (53) is configured to engage with the first threaded section (124) to allow the flange (31) of the guiding sleeve (30) to be secured between the abutting edge (123) of the main body (10) and a rear end of the first peripheral cover (51). Since the outer tube (32) is separated with the inner tube (33), when the water guiding tube (20) and the axle shaft (40) are connected and received in the guiding sleeve (30), the axle shaft (40) is configured to be received in the outer tube (32) while a rear portion of the water guiding tube (20) is configured to be received in the inner tube (33). The control ring (60) having a through hole (601) is configured to be disposed on an outer periphery of the nozzle cap (50), and a connecting unit (61) is configured to sequentially penetrate through the through hole (601) and the elongated hole (54) of the nozzle cap (50) to connect to the connecting hole (403) of the axle shaft (40) such that the control ring (60), the water guiding tube (20) and the axle shaft (40) are connected and moved synchronously. The spray head (70) comprises a shell (71) and an inner channel (72), which are connected to each other, and a fifth threaded section (73) is formed at an inner surface of the inner channel (72). Through engaging the fifth threaded section (73) with the fourth threaded section (56), the spray head (70) is configured to be secured on the extension tube (55) of the nozzle cap (50). Also, a stepped portion (74) configured to connect to a tilted surface (75) is connected to a front end of the inner channel (72), and a sectional diameter of the stepped portion (74) is gradually expanded from a rear end to a front end thereof. The block ring (80) has a sixth threaded section (81) formed at an inner periphery thereof, and the sixth threaded section (81) is configured to engage with the second threaded section (205) of the water guiding tube (20) to allow the block ring (80) to be installed on the water guiding tube (20). As a result, the water guiding tube (20) is configured to stick out of the spray head (70), and by turning the spray head (70), the water spray gun is configured to spay different patterns of water streams from a space between the spray head (70) and the water guiding tube (20).

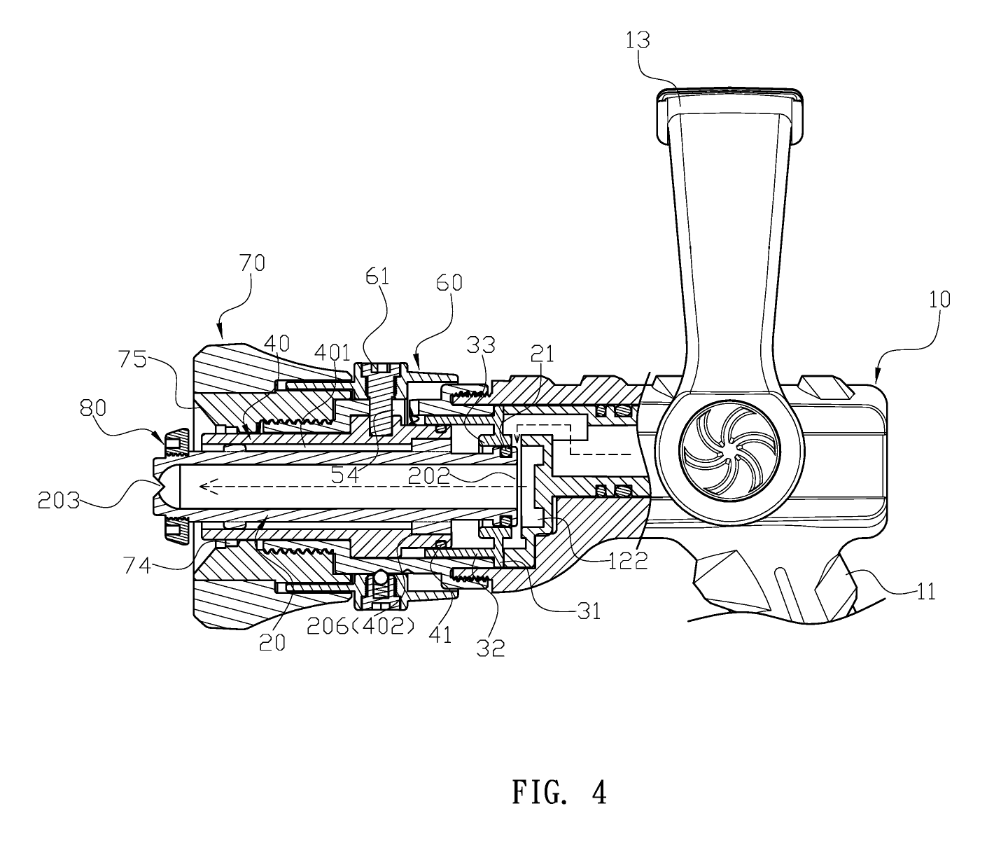

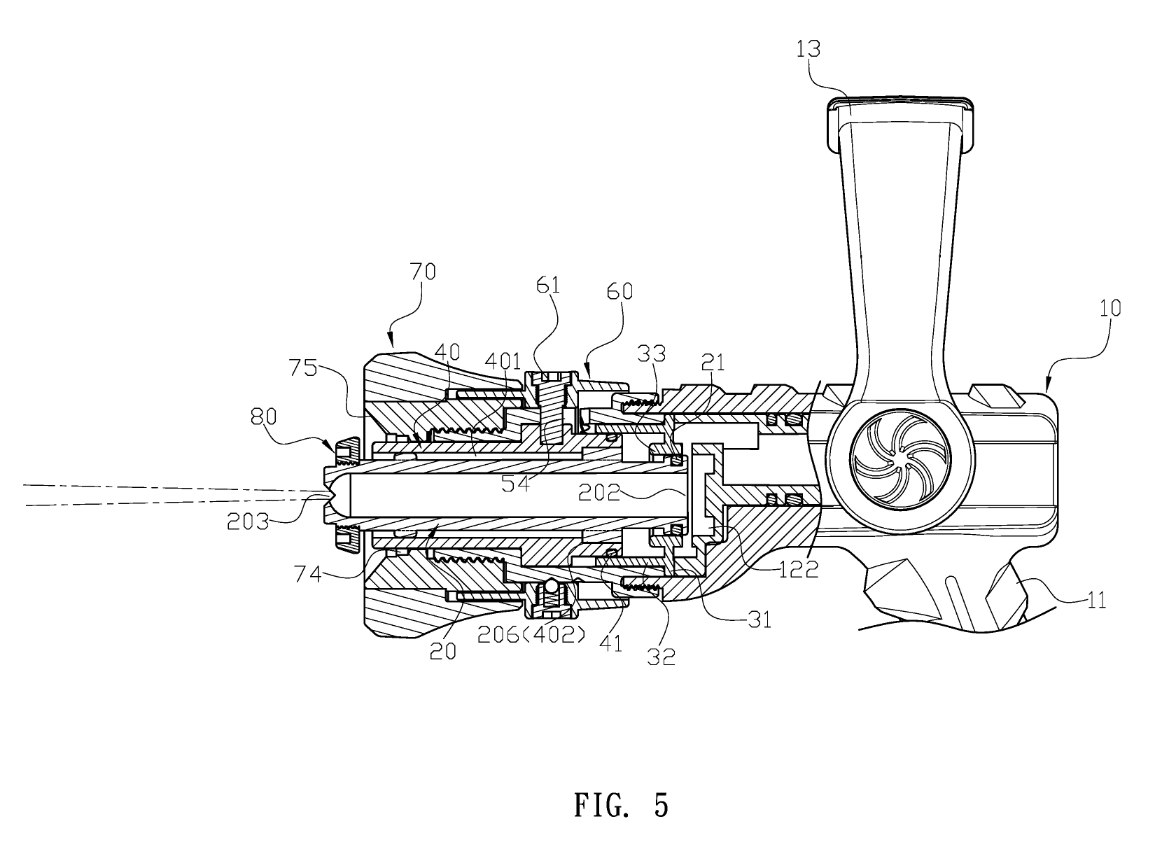

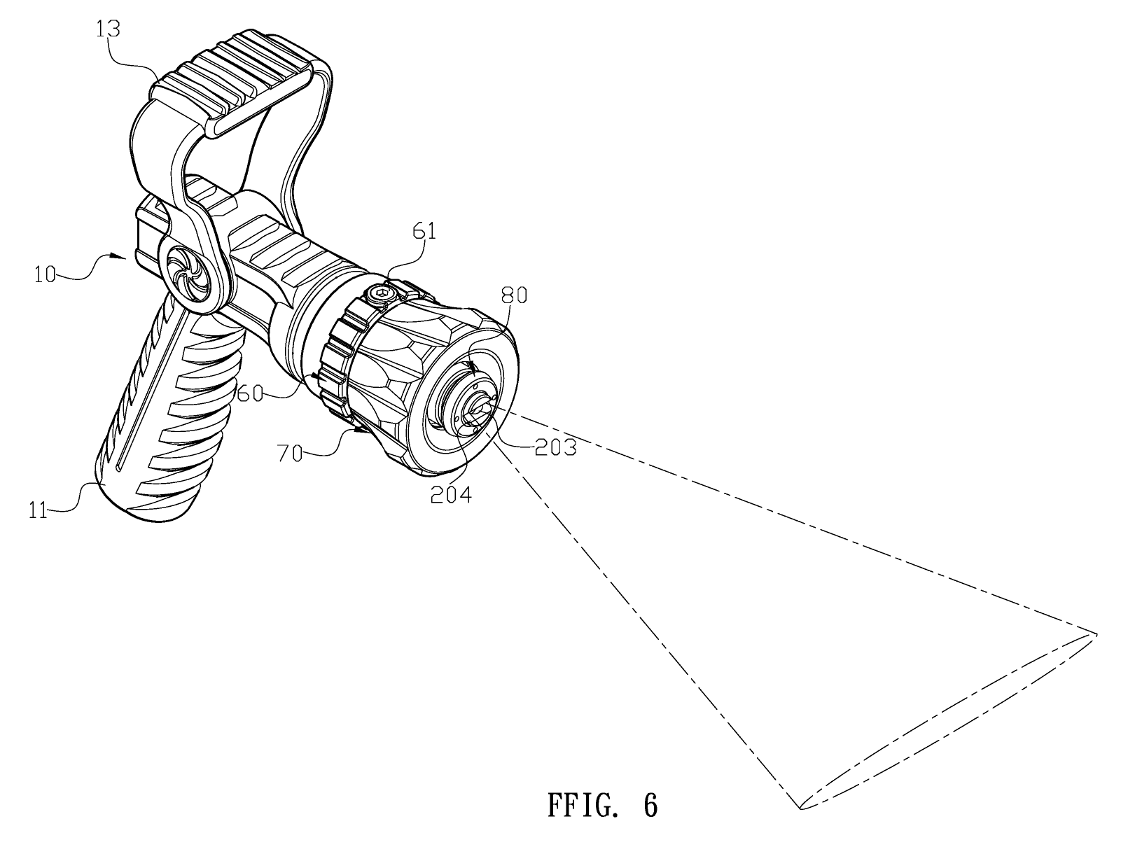

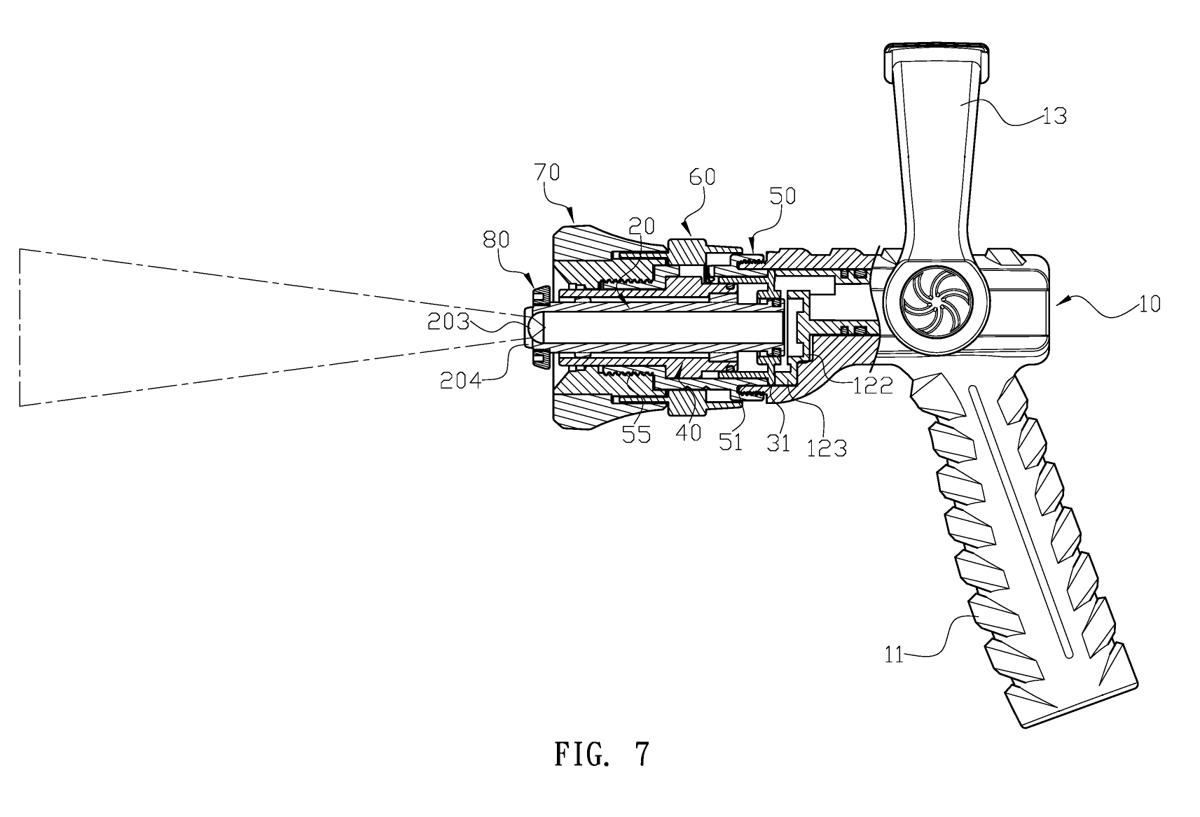

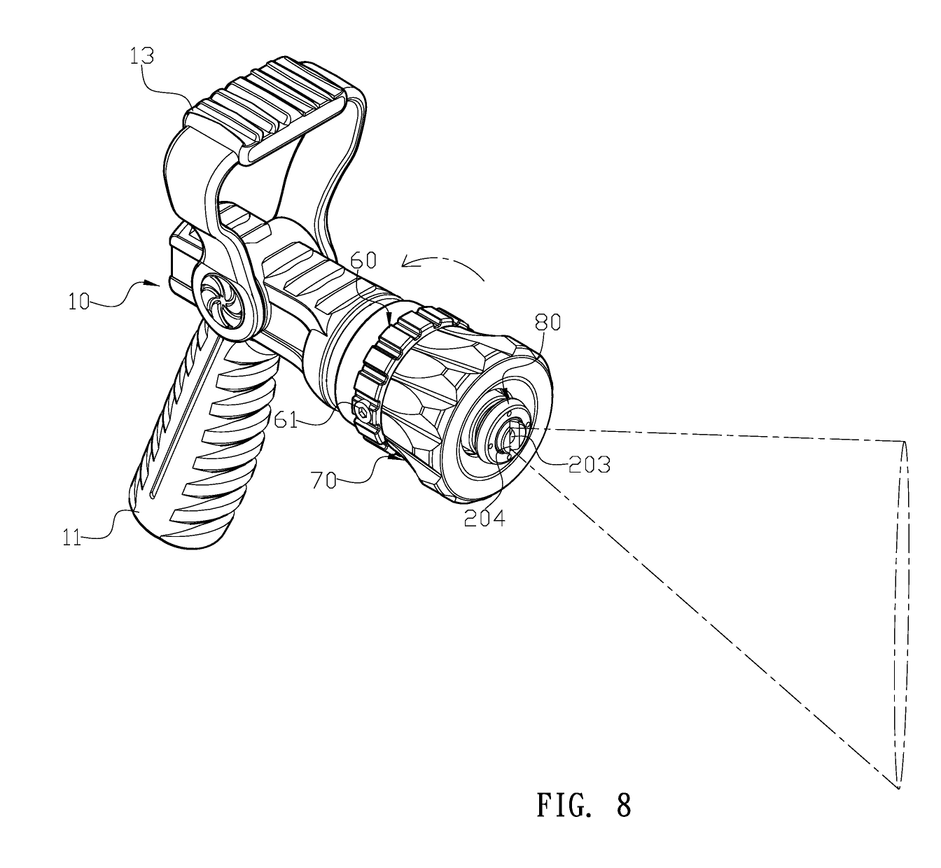

In actual application, with the elongated hole (54), the control ring (60) is configured to be pushed forward so as to drive the water guiding tube (20) with the axle shaft (40) to move forward. Thus, the open end (202) of the water guiding tube (20) is configured to be positioned far from and not covered by the water-resisting cover (122) of the main body (10), and the inner tube (33) of the guiding sleeve (30) is configured to be blocked by the first sealing ring (21) of the water guiding tube (20) such that the water stream inside the water spray gun is configured to flow from the open end (202) through an inner passageway of the water guiding tube (20) toward the water outlet hole (203) (referring to FIG. 4). Through the water guiding groove (204), the water stream spraying out of the water outlet hole (203) in a solid stream pattern is configured to flow toward two lateral ends of the water guiding groove (204) thereby performing a powerful and wide-range water stream as a water bloom when spraying out of the water spray gun (as shown in FIGS. 5 and 6). As a result, the powerful and wide-range water stream is configured to remove dust and dirt attached on the wall or floor, thus achieving clean effect. Also, the control ring (60) moved along the elongated hole (54) is configured to drive the water guiding tube (20) with the axle shaft (40) to have rotation synchronously such that the said water bloom is configured to have wider spraying angles in all directions, thus avoiding the dead angle of spraying (as shown in FIGS. 7 and 8).

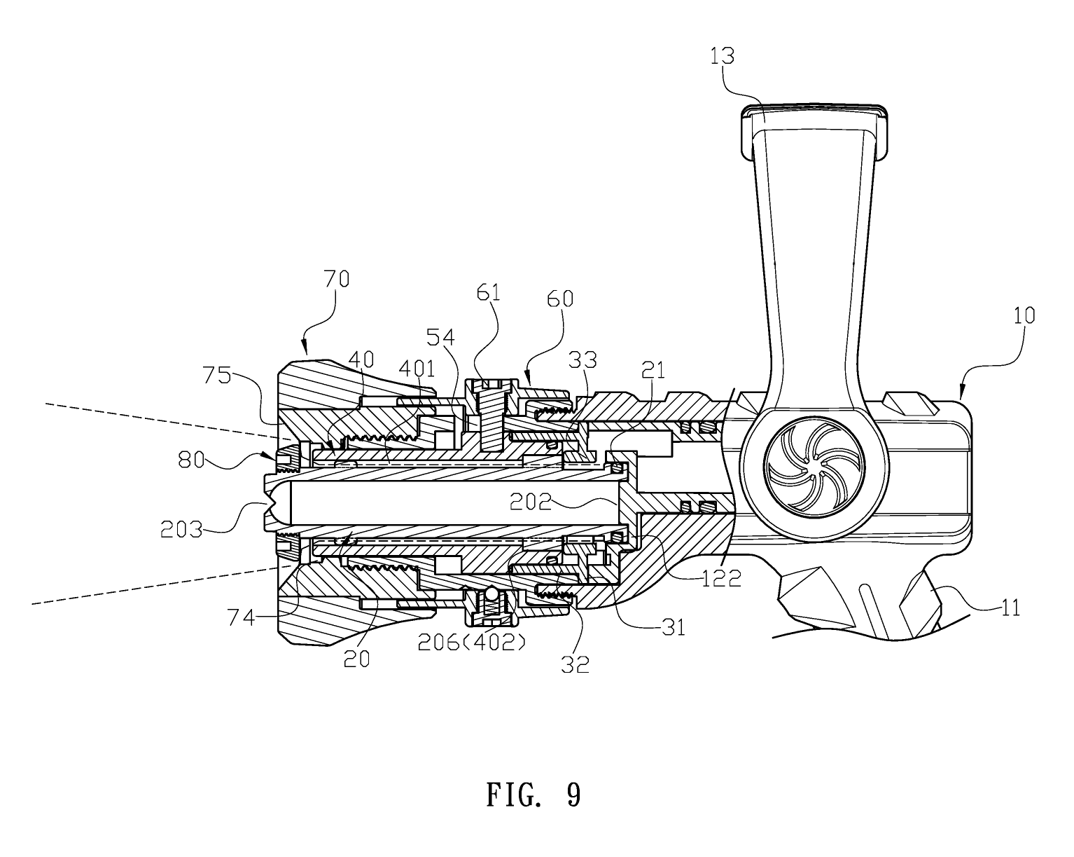

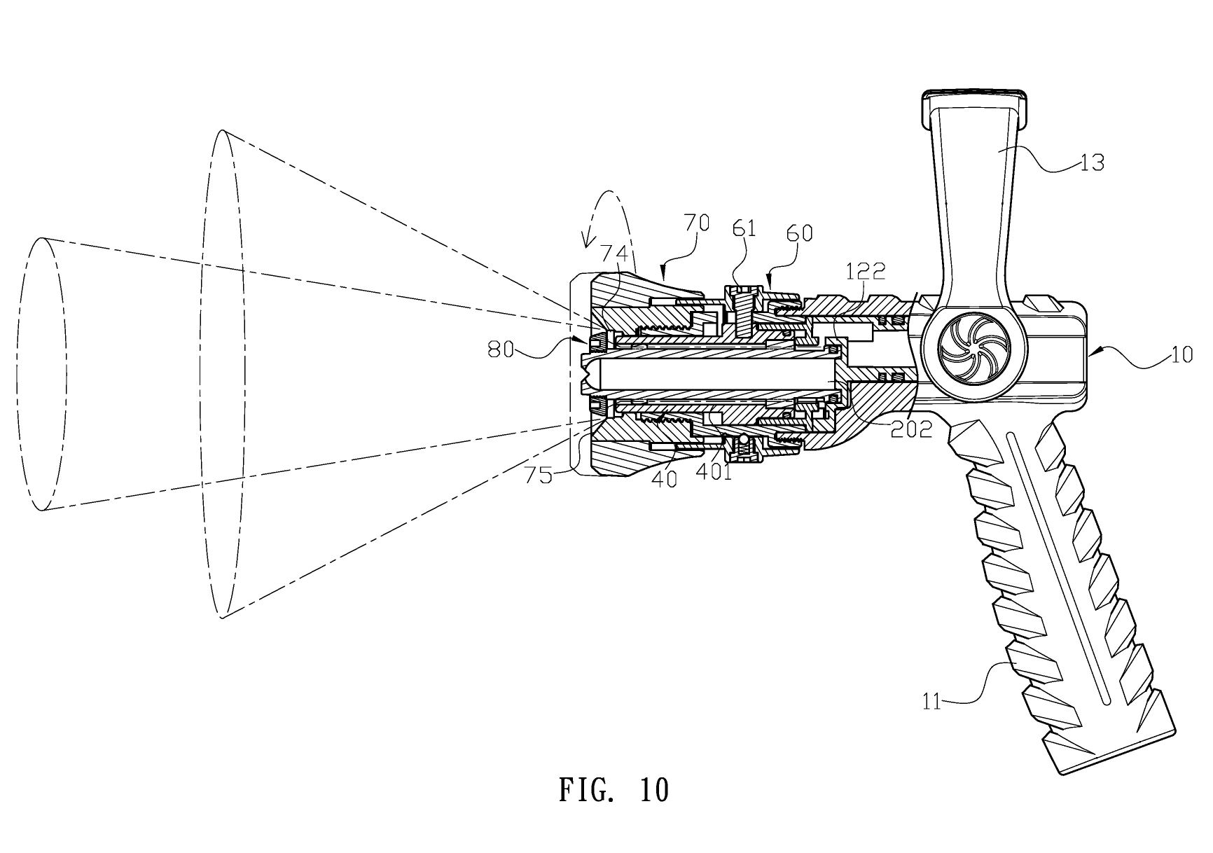

Moreover, by pulling the control ring (60) rearward, the water guiding tube (20) is configured to be driven back and covered by the water-resisting cover (122) such that the open end (202) of the water guiding tube (20) is configured to be blocked and the first sealing ring (21) driven and moved rearward is configured to be detached from the inner tube (33) of the guiding sleeve (30). As a result, the water stream is configured to flow through the inner tube (33) and the water flow channels between the water guiding tube (20) and the axle shaft (40) toward a front portion of the water spray gun (as shown in FIG. 9). By rotating the spray head (70) clockwise or counterclockwise, the block ring (80) is configured to align with the stepped portion (74) or the tilted surface (75), and the water stream blocked by the block ring (80) is configured to scatter around to have contacts with the stepped portion (74) or the tilted surface (75) thereby spraying out of the water spray gun in the straight line or in the scattering stream pattern (as shown in FIG. 10), which is convenient to use in garden watering or item washing.

In one embodiment, a control valve controlled by the operating unit (13) is formed between the handle (11) and the barrel portion (12) of the main body (10), and through pulling the operating unit (13), the control valve is driven and rotated synchronously with the operating unit (13) thus achieving the on/off operation of the main body (10).

In another embodiment, an arc edge (34) protrudes from a rear end of the flange (31) of the guiding sleeve (30), and an engaging recess (341) is formed on the arc edge (34), and a mounting block (125) formed inside the connecting opening (121) of the main body (10) is configured to engage with the engaging recess (341), thereby preventing the guiding sleeve (30) from individually rotating inside the connecting opening (121).

In still another embodiment, the water guiding tube (20) is first inserted into the axle shaft (40) and positioned through a method of high frequency.

In a further embodiment, the first peripheral cover (51) of the nozzle cap (50) comprises two rows of locating holes (57) respectively formed at a front portion and a rear portion thereof, and the control ring (60) has a locating unit (62) located at a position aligned with the two rows of the locating holes (57). Wherein the locating unit (62) further comprises at least a spring and a locating bolt. The locating bolt is configured to selectively insert a preferred locating hole (57) to position the control ring (60) in the situation when the control ring (60) is pushed forward or pulled rearward after been turned.

In still a further embodiment, a plurality of engaging slots (541) are sequentially formed along an edge of a rear portion of the elongated hole (54), and after changing the water stream angle, the control ring (60) is configured to be pull back and the connecting unit (61) of the control ring (60) is configured to engage with the engaging slots (541), thereby preventing the control ring (60) from individually rotating when the spraying head (70) is turned.

Comparing with conventional gardening water spray guns, the present invention is advantageous because: the water spray gun of the present invention not only has the functions of garden watering and item washing but also is configured to provide powerful and wide-range water stream as a water bloom, which is configured to easily remove dust and dirt attached on the wall or floor and improve the practicability of the water spray gun.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A gardening water spray gun comprising:
a main body having a handle and a barrel portion, which are connected and communicated with each other, and a connecting opening formed at a front end of the barrel portion; a water-resisting cover and an abutting edge respectively formed inside the connecting opening, and a first threaded section, which is formed at an outer periphery of the front end of the barrel portion, configured to allow a nozzle cap to engage thereon;
a water guiding tube comprising a close end and an open end, which are respectively formed at a front end and a rear end of the water guiding tube; a water outlet hole axially penetrating through the close end, and the close end further having an elongated water guiding groove which passes through the water outlet hole; a first sealing ring disposed on an outer periphery of the open end, and a second threaded section formed at an outer periphery of the close end; a plurality of engaging blocks, which are formed at an outer periphery of the water guiding tube, located close to the open end such that each of water flow channels formed between two adjacent engaging blocks;
a guiding sleeve having a flange, and an outer tube protruding from a front end thereof; an inner tube connected to an inner periphery of the guiding sleeve;
an axle shaft comprising a central hole axially penetrating through a central portion thereof; wherein an inner diameter of the central hole is slightly larger than an outer diameter of the water guiding tube; a plurality of engaging grooves formed at a rear portion of the central hole; wherein the central hole is configured to be penetrated by the water guiding tube, and the engaging grooves are configured to be engaged with the engaging blocks, thereby allowing the water guiding tube to connect to and move with the axle shaft synchronously; a connecting hole formed at an outer periphery of the axle shaft, and a second sealing ring disposed on a rear portion of the outer periphery of the axle shaft;
the nozzle cap comprising a first peripheral cover, and a rear end thereof connected to a second peripheral cover; wherein the first peripheral cover and the second peripheral cover are axially separated to form a peripheral groove therebetween, and the peripheral groove is configured to receive an outer edge of the connecting opening; a third threaded section formed at an inner surface of the second peripheral cover, and an elongated hole with a suitable rotation angle penetrating through a surface of the first peripheral cover; an extension tube, which protrudes from a front end of the nozzle cap, communicated with an inner space of the nozzle cap, and a fourth threaded section formed on an outer periphery of the extension tube; when the guiding sleeve put into the connecting opening of the main body, the flange configured to bear against the abutting edge to limit a position of the guiding sleeve; the water guiding tube and the axle shaft, which are connected to each other, configured to be received in the guiding sleeve, and the third threaded section configured to engage with the first threaded section to allow the flange of the guiding sleeve to be secured between the abutting edge of the main body and a rear end of the first peripheral cover; the outer tube configured to be separated with the inner tube; when the water guiding tube together with the axle shaft received in the guiding sleeve, the axle shaft configured to be received in the outer tube while a rear portion of the water guiding tube configured to be received in the inner tube;
a control ring, which has a through hole, configured to be disposed on an outer periphery of the nozzle cap, and a connecting unit configured to sequentially penetrate through the through hole and the elongated hole of the nozzle cap to connect to the connecting hole of the axle shaft such that the control ring, the water guiding tube and the axle shaft are connected and moved synchronously;
a spray head comprising a shell and an inner channel, which are connected to each other, and a fifth threaded section formed at an inner surface of the inner channel; through engaging the fifth threaded section with the fourth threaded section, the spray head configured to be secured on the extension tube of the nozzle cap; and
a block ring having a sixth threaded section formed at an inner periphery thereof, and the sixth threaded section configured to engage with the second threaded section of the water guiding tube to allow the block ring to be installed on the water guiding tube; the water guiding tube configured to stick out of the spray head, and by turning the spray head, the water spray gun configured to spay different patterns of water streams from a space between the spray head and the water guiding tube.

2. The gardening water spray gun of claim 1, wherein a control valve controlled by the operating unit is formed between the handle and the barrel portion of the main body.

3. The gardening water spray gun of claim 1, wherein an arc edge protrudes from a rear end of the flange of the guiding sleeve, and an engaging recess is formed on the arc edge, and a mounting block formed inside the connecting opening of the main body is configured to engage with the engaging recess, thereby preventing the guiding sleeve from individually rotating inside the connecting opening.

4. The gardening water spray gun of claim 1, wherein the outer tube is longer than the inner tube.

5. The gardening water spray gun of claim 1, wherein the water guiding tube is inserted into the axle shaft and positioned through a method of high frequency.

6. The gardening water spray gun of claim 1, wherein the first peripheral cover of the nozzle cap comprises two rows of locating holes respectively formed at a front portion and a rear portion thereof, and the control ring has a locating unit located at a position aligned with the two rows of the locating holes; and wherein the locating unit further comprises at least a spring and a locating bolt.

7. The gardening water spray gun of claim 1, wherein a plurality of engaging slots are sequentially formed along an edge of a rear portion of the elongated hole.

8. The gardening water spray gun of claim 1, wherein a stepped portion configured to connect to a tilted surface is connected to a front end of the inner channel, and a sectional diameter of the stepped portion is gradually expanded from a rear end to a front end thereof.
